(19) United States
(12) Patent Application Publication
(10) Pub. No.: US 2012/0062705 A1
(43) Pub. Date: Mar. 15, 2012

(54) OVERLAPPING CHARGE ACCUMULATION DEPTH SENSORS AND METHODS OF OPERATING THE SAME

(76) Inventors: Ilia Ovsiannikov, Studio City, CA (US); Seung Hoon Lee, Yongin-si (KR); Dong Ki Min, Seoul (KR)

(21) Appl. No.: 13/224,435

(22) Filed: Sep. 2, 2011

(30) Foreign Application Priority Data
Sep. 3, 2010 (KR) 10-2010-0086715

(51) Int. Cl. H04N 13/02

(52) U.S. Cl. 348/46; 348/E13.074

(57) ABSTRACT

One embodiment includes sequentially resetting rows and applying a gating signal to the rows sequentially in order in which the rows are reset; accumulating at each of the rows photocharge generated in response to an optical signal reflected from an object and the gating signal for an integration time; and reading a result of photocharge accumulation from each of the rows. A phase of the gating signal applied to a row with respect to which the reading has been completed, may be changed. A period of photocharge accumulation based on the gating signal having a changed phase in at least one row, which has been subjected to the reading and then reset, may overlap a period of photocharge accumulation in at least one row in which photocharge accumulation based on the gating signal having a phase before being changed is being carried out.

### CROSS-REFERENCE TO RELATED APPLICATION

This application claims priority under 35 U.S.C. §119(a) from Korean Patent Application No. 10-2010-0086715 filed on Sep. 3, 2010, the disclosure of which is hereby incorporated by reference in its entirety.

### BACKGROUND

Various embodiments described herein relate to techniques for estimating a distance to an object, and more particularly, to depth sensors for estimating a distance to an object using a rolling shutter to generate a depth image and methods of estimating a distance using the same.

Rolling shutter depth sensors may be used to estimate distances in an image and/or to create three-dimensional images. Rolling shutter depth sensors include a depth sensor array, such as a CMOS depth sensor array and a rolling shutter that establishes staggered integration times for respective rows of the image. Time-of-Flight (TOF) three-dimensional sensing may thereby be provided.

When a rolling shutter usually used in two-dimensional (2D) sensors is used in three-dimensional (3D) sensors, i.e., depth sensors, the frame rate of the 3D sensors generally decreases. This is because it takes long time to accumulate photocharge at a current frame until photocharge is accumulated for a subsequent frame and the phase of an optical signal emitted to an object to output a result of photocharge accumulation is changed when the rolling shutter is used in 3D sensors.

### SUMMARY

Some embodiments described herein can provide depth sensors for increasing a frame rate using a rolling shutter and methods of estimating a distance using the depth sensor.

Some embodiments described herein provide methods of estimating a distance using a depth sensor. These methods include (a) sequentially resetting a plurality of rows and applying a gating signal to the plurality of rows sequentially in order in which the rows are reset; (b) accumulating at each of the rows photocharge generated in response to an optical signal reflected from an object and the gating signal for an integration time; and (c) reading a result of photocharge accumulation from each of the rows sequentially in order of completion of the photocharge accumulation.

Here, operations (a) through (c) may be sequentially repeated in a plurality of cycles. A phase of the gating signal applied to a row with respect to which the reading of the result of photocharge accumulation has been completed, may be changed by a predetermined angle. A period of photocharge accumulation based on the gating signal having a changed phase in at least one row, which has been subjected to the reading and then reset, may overlap a period of photocharge accumulation in at least one row in which photocharge accumulation based on the gating signal having a phase before being changed is being carried out.

Other embodiments provide depth sensors including a depth sensor array including a plurality of rows, each of which includes a plurality of depth pixels, accumulates photocharge generated in response to an optical signal reflected from an object and a gating signal for an integration time, and outputs a result of photocharge accumulation in response to completion of the photocharge accumulation; and a row control block configured to sequentially reset the plurality of rows and apply the gating signal to the plurality of rows sequentially in order in which the rows are reset.

In some of these embodiments, the row control block may change a phase of the gating signal applied to a row, with respect to which the outputting of the result of photocharge accumulation has been completed, by a predetermined angle and perform a plurality of cycles of application of the reset signal and the gating signal with respect to an entire single frame. A period of photocharge accumulation in at least one reset row in response to the gating signal having a changed phase may overlap a period of photocharge accumulation in at least one row in which photocharge accumulation based on the gating signal having a phase before being changed is being carried out.

Further embodiments provide depth sensors including a depth sensor array including a plurality of rows each of which includes a plurality of depth pixels, accumulates photocharge generated in response to an optical signal reflected from an object and a pair of gating signals for an integration time, and outputs a result of photocharge accumulation in response to completion of the photocharge accumulation; and a row control block configured to sequentially reset the plurality of rows and apply the pair of gating signals to the plurality of rows sequentially in order in which the rows are reset.

In some of these embodiments, the row control block may change a phase of each of the pair of gating signals applied to a row, with respect to which the outputting of the result of photocharge accumulation has been completed, by a predetermined angle and perform a plurality of cycles of application of the reset signal and the pair of gating signals with respect to an entire single frame. A period of photocharge accumulation in at least one pair of reset rows based on the pair of gating signals each having a changed phase may overlap a period of photocharge accumulation in at least one row in which photocharge accumulation based on the pair of gating signals each having a phase before being changed is being carried out.

Various other embodiments described herein can provide a depth sensor that includes a plurality of pixel rows that sequentially store charge generated in response to an optical signal that is reflected from an object, and methods of operating these sensors. In some embodiments, a second pixel row that stores charge subsequent to a first pixel row stores charge, is reset before the first pixel row has a completed a reading operation of the charge that was stored therein. In other embodiments, the second pixel row is reset before the first pixel row has begun a reading operation of the charge that was stored therein. In still other embodiments, the second pixel row is reset and charge is begun to be stored in a second pixel row, while the first pixel row is storing charge therein. In yet other embodiments, the second pixel row is reset and charge is begun to be stored in the second pixel row, immediately after a sufficient time has elapsed that provides non-overlapping reading operations of the first and second pixel rows.

Yet other embodiments store charge in a third pixel row in response to a gating signal, while simultaneously storing charge in a fourth pixel row in response to a phase-changed version of the gating signal. These embodiments may also be provided separately from the embodiments described above by storing charge in a first pixel row in response to a gating signal while simultaneously storing charge in a second pixel row in response to a phase-changed version of the gating signal.

### BRIEF DESCRIPTION OF THE DRAWINGS

The above and other features and advantages of the present invention will become more apparent by describing in detail various embodiments thereof with reference to the attached drawings in which:

FIG. 1 is block diagram of a depth sensor according to various embodiments described herein;

FIG. 2 is a diagram comparing a conventional rolling shutter for a plurality of rows with a rolling shutter performed in a depth sensor according to various embodiments described herein;

FIG. 3 is a diagram comparing a conventional rolling shutter for a single frame with a rolling shutter performed in a depth sensor having a 1-tap structure according to various embodiments described herein;

FIG. 4 is a diagram explaining the change in a gating signal applied to a plurality of rows in a depth sensor array of the depth sensor having the 1-tap structure according to various embodiments described herein;

FIG. 5 is a layout of a depth pixel included in the depth sensor array of the depth sensor having the 1-tap structure;

FIG. 6 is a diagram showing gating signals applied to a depth pixel in the 1-tap structure illustrated in FIG. 5;

FIG. 7 is a circuit diagram of a photoelectric conversion element and transistors in an active area illustrated in FIG. 5;

FIG. 8 is a schematic block diagram of a row control block according to various embodiments described herein;

FIG. 9 is a schematic block diagram of a row control block according to other embodiments described herein;

FIG. 10 is a block diagram of a part of a row control block according to further embodiments described herein;

FIG. 11 is a schematic timing chart showing the operation of the row control block illustrated in FIG. 10;

FIGS. 12A through 12C are diagrams showing a flip-flop illustrated in FIG. 10, a truth table, and the operation of the flip-flop, respectively;

FIG. 13 is a block diagram of a row control block according to other embodiments described herein;

FIG. 14 is a schematic timing chart showing the operation of the row control block illustrated in FIG. 13;

FIG. 15 is a block diagram of a part of a row control block according to yet other embodiments described herein;

FIGS. 16 and 17 are timing charts showing the operation of the depth sensor illustrated in FIG. 1;

FIG. 18 is a flowchart of estimating a distance using a depth sensor according to various embodiments described herein;

FIG. 19 is a flowchart of generating a frame signal in the flowchart of FIG. 18 using a depth sensor including a depth pixel array having a 1-tap structure;

FIG. 20 is a layout of a depth pixel included in a depth sensor array of a depth sensor having a 2-tap structure;

FIG. 21 is a diagram comparing a conventional rolling shutter for a single frame with a rolling shutter performed in a depth sensor having a 2-tap structure according to various embodiments described herein;

FIG. 22 is a diagram explaining the change in a gating signal applied to a plurality of rows in a depth sensor array of a depth sensor having a 2-tap structure according to various embodiments described herein;

FIG. 23 is a flowchart of the operation of generating a frame signal in the flowchart of FIG. 18 using a depth sensor including a depth pixel array having a 2-tap structure;

FIG. 24 is a block diagram of a three-dimensional (3D) image sensor according to various embodiments described herein;

FIG. 25 is a block diagram of a signal processing system including the depth sensor illustrated in FIG. 1; and

FIG. 26 is a block diagram of an image processing system including the 3D image sensor illustrated in FIG. 24.

### DETAILED DESCRIPTION OF THE EMBODIMENTS

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

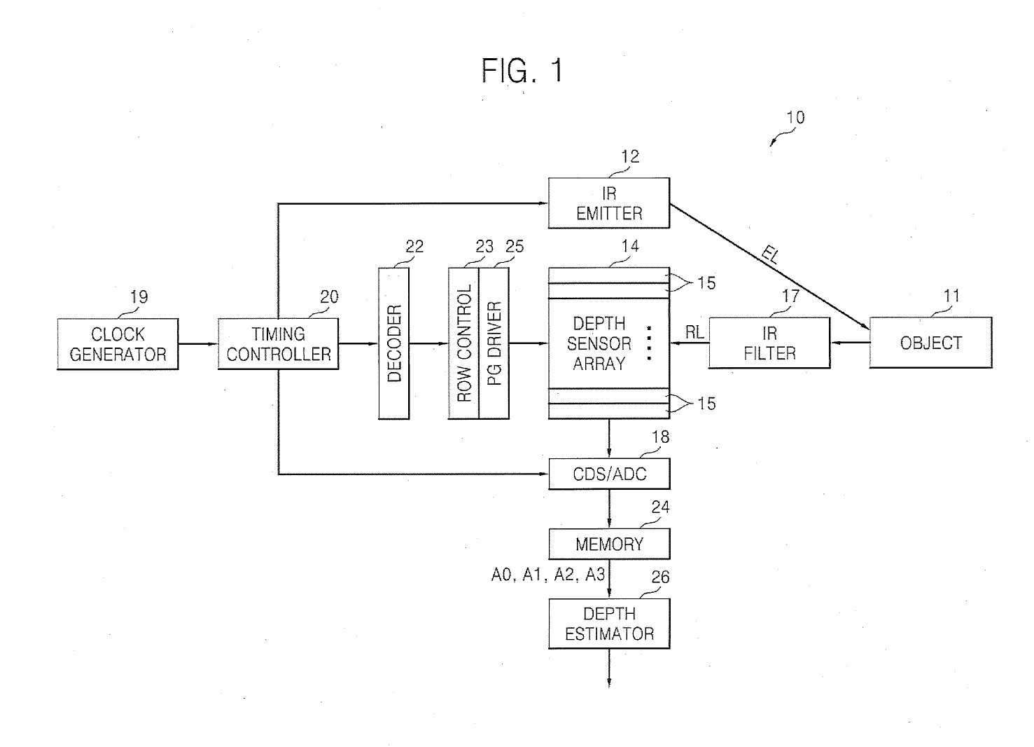

FIG. 1 is block diagram of a depth sensor 10 according to various embodiments described herein. The depth sensor 10 may estimate a distance to an object using a time-of-flight (TOF) principle and a rolling shutter and generate a depth image. While using the rolling shutter, the depth sensor 10 increases a frame rate by fixing the phase of an optical signal emitted to the object and controlling the phase of a gating signal applied to rows in a depth pixel array 14.

The depth sensor 10 may be implemented as a single chip to calculate depth information or may be used together with a color image sensor chip to measure both of three-dimensional (3D) image information and depth information. When the depth sensor 10 is implemented as a 3D image sensor, a depth pixel for detecting depth information and pixels for detecting image information may be implemented together in a single pixel array. The depth sensor 10 using the TOF principle may emit an optical signal EL using an infrared ray (IR) and/or other emitter 12 and estimate a distance to an object 11 based on a phase difference between the optical signal (e.g., an IR signal) EL and an IR signal RL reflected from the object 11.

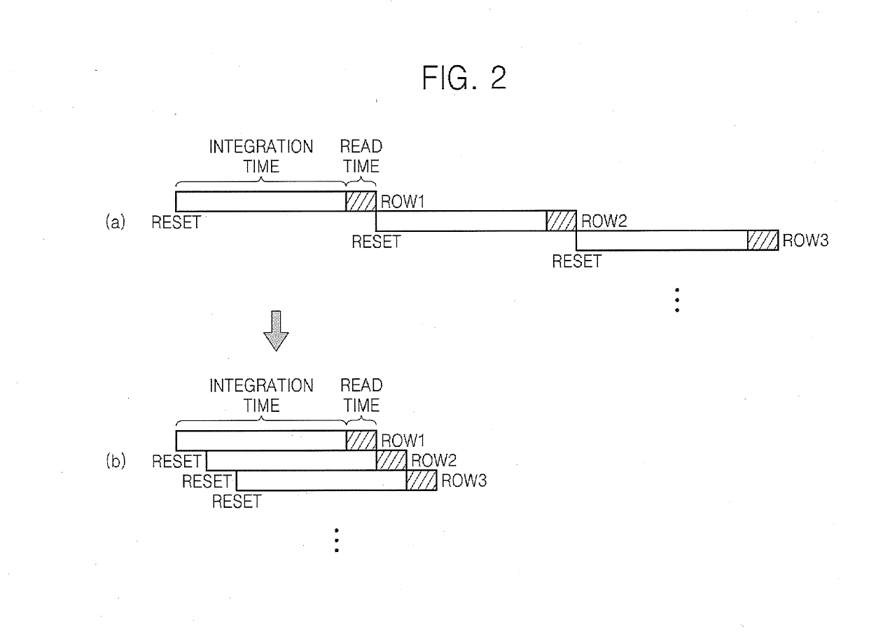

FIG. 2 is a diagram comparing a conventional rolling shutter (a) for a plurality of rows with a rolling shutter (b) performed in the depth sensor 10 according to various embodiments described herein. In the conventional rolling shutter (a), only after a reset, photocharge accumulation for an integration time, and a read of the accumulated photocharge are completed for a single current row, the reset, photocharge accumulation, and read operations are performed for a subsequent row.

In the rolling shutter (b) performed in the depth sensor 10, however, a plurality of rows are reset at a predetermined interval and the photocharge accumulation and read operations for each row are performed in parallel. Accordingly, a frame rate obtained when the rolling shutter (b) according to the current embodiments is used can be higher than a frame rate obtained when the conventional rolling shutter (a) is used.

Accordingly, FIG. 2 illustrates, at (b), methods of operating a depth sensor that includes a plurality of pixel rows that sequentially store charge generated in response to an optical signal that is reflected from an object. These methods comprise resetting a second pixel row that stores charge subsequent to a first pixel row stores charge, before the first pixel row has completed a reading operation of charge that was stored therein. FIG. 2 also illustrates other embodiments at (b), wherein the resetting comprises resetting the second pixel row before the first pixel row has begun a reading operation of the charge that was stored therein. FIG. 2 also illustrates yet other embodiments at (b) wherein the resetting comprises resetting the second pixel row and beginning to store charge in the second pixel row, while the first pixel row is storing charge therein. FIG. 2 also illustrates still other embodiments at (b), wherein the resetting comprises resetting the second pixel row and beginning to store charge in the second pixel, immediately after a sufficient time has elapsed that provides non-overlapping reading operations of the first and second pixel rows. Analogous depth sensors are also illustrated when (b) of FIG. 2 is combined with, for example, FIG. 1.

Referring again to FIG. 1, the depth sensor 10 includes the IR emitter 12, the depth sensor array 14, an IR filter 17, a correlated double sampling (CDS)/analog-to-digital converting (ADC) circuit 18, a clock generator 19, a timing controller 20, a decoder 22, a memory 24, a row control block 23, a gating signal (PG) driver 25, and a depth, estimator 26. The depth sensor 10 may also include an active load circuit (not shown) controlled by the timing controller 20 to transmit a signal of a column line to the CDS/ADC circuit 18. The depth sensor 10 may also include a lens (not shown) which focuses light reflected from the object 11 on the IR filter 17. The operation of a lens module (not shown) including the lens may be controlled by the timing controller 20.

The IR emitter 12 may emit the IR optical signal EL having a phase controlled by the timing controller 20. The IR emitter 12 may be implemented by a light emitting diode (LED), an organic light emitting diode (OLED) and/or another emitter. Although the depth sensor 10 may include a plurality of IR emitters around the depth sensor array 14, only one IR emitter 12 is illustrated in FIG. 1 for clarity of the description. In embodiments of FIG. 1, the phase of the optical signal EL emitted to the object 11 is not changed but is maintained constant.

The depth sensor array 14 may include a plurality of depth pixels (not shown) arranged in a matrix of a plurality of pixel rows 15 and a plurality of pixel columns, also referred to herein simply as “rows” and “columns”. The depth pixels may generate a plurality of frame signals based on the optical signal RL reflected from the object 11 and a plurality of gating signals periodically applied with a predetermined phase difference to the depth pixels. The decoder 22 decodes and outputs a row address signal so as to select rows 15 to which reset signals for resetting depth pixels in units of rows 15 and the gating signals will be applied.

In other words, in accordance with a rolling shutter, the depth sensor array 14 may accumulate photocharge generated in each row 15 in response to the optical signal RL reflected from the object 11 and the gating signals for the same integration time and sequentially output photocharge accumulation results in the order in which photocharge accumulation is completed. At this time, the row control block 23 may sequentially output the reset signals to the respective rows and sequentially apply the gating signals to the respective rows in the order of being reset.

The row control block 23 may perform a plurality of cycles of the application of a reset signal and a gating signal (hereinafter, referred to as “reset and gating signal application”) with respect to an entire single frame. In detail, the row control block 23 changes by a predetermined phase angle the phase of the gating signal applied to a row with respect to which output of a photocharge accumulation result is completed so as to perform a plurality of cycles of the reset and gating signal application. For instance, when the depth sensor array 14 has a 1-tap structure, the row control block 23 may perform 4 cycles of the reset and gating signal application with respect to an entire single frame by changing the phase of the gating signal by an angle of 90 degrees at each cycle.

The phase of the gating signal sequentially applied to a plurality of rows at a first cycle may be the same as the phase of the optical signal EL emitted to the object 11. For instance, when the depth sensor array 14 has a 1-tap structure, the gating signal and the optical signal EL may have a phase of 0 degrees.

Thereafter, when the cycle is repeated, the phase of the gating signal applied to a row with respect to which a read operation on a photocharge accumulation result is completed may be changed by the predetermined phase angle from the optical signal EL emitted to the object 11. For instance, when the depth sensor array 14 has a 1-tap structure and the phase of the gating signal at the first cycle is 0 degrees, the phase of the gating signal may be changed from 0 degrees to 90, 180, and 270 degrees sequentially as the number of cycles increases. Alternatively, as the number of cycles increases, the phase of the gating signal may be decreased by 90 degrees at each cycle.

The PG driver 25 is a circuit for driving a gating signal and a reset signal output from the row control block 23 to a row. The PG driver 25 includes a plurality of buffers corresponding to the rows, respectively, of the depth sensor array 14.

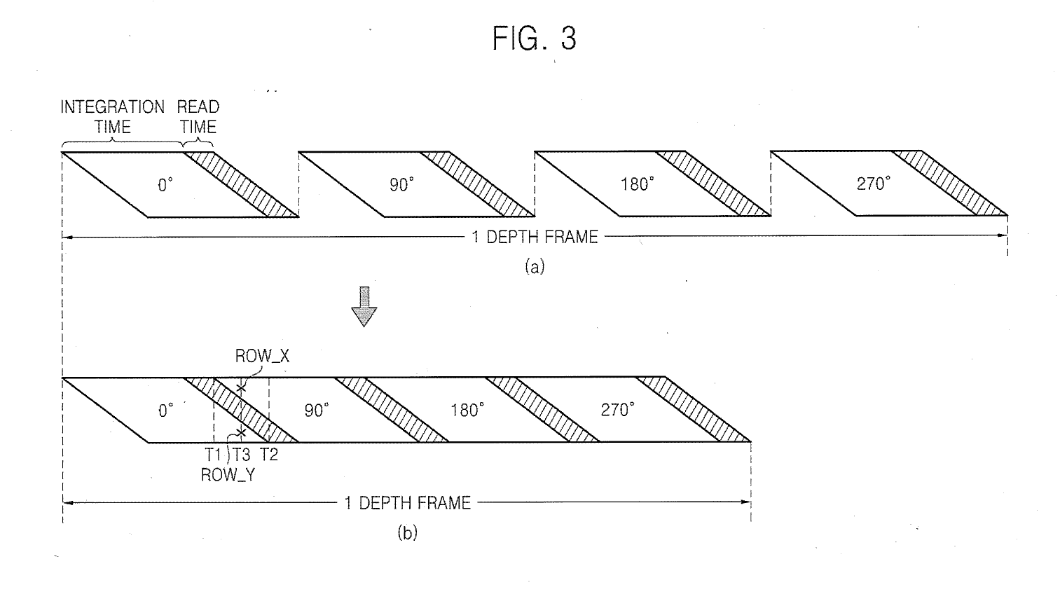

FIG. 3 is a diagram comparing a conventional rolling shutter (a) for a single frame with a rolling shutter (b) performed in the depth sensor 10 having a 1-tap structure according to various embodiments described herein. Here, it is assumed that the phase of the optical signal EL emitted by the IR emitter 12 is 0 degrees.

When the conventional rolling shutter (a) is used, with respect to the single frame, only after the read operation of a result of photocharge accumulation based on a gating signal having 0, 90, and 180 degrees is completed, the read operation of a result of photocharge accumulation based on the gating signals having 90, 180, and 270 degrees is performed, respectively.

However, in the rolling shutter (b) performed in the depth sensor 10, with respect to the single frame, even while the read operation of a result of photocharge accumulation based on a gating signal having a phase of 0 degrees is being performed, photocharge accumulation based on the gating signal having a phase of 90 degrees starts at a row at which the read operation of a photocharge accumulation result has been completed. This operation also applies when the phase of the gating signal changes from 90 degrees to 180 degrees and changes from 180 degrees to 270 degrees.

In other words, in the rolling shutter (b) performed in the depth sensor 10, a period of photocharge accumulation in at least one reset row based on the gating signal having a changed phase overlaps a period of photocharge accumulation in at least one row in which photocharge accumulation based on the gating signal having a phase before being changed is being carried out. Referring to FIG. 3, it can be seen that at a time point T3 in a period between time points T1 and T2 during which the phase of the gating signal changes from 0 degrees to 90 degrees, a period of photocharge accumulation in a reset row ROW_X based on the gating signal having a phase of 90 degrees overlaps a period of photocharge accumulation in another row ROW_Y based on the gating signal having a phase of 0 degrees. Such overlapping also applies when the phase of the gating signal changes from 90 degrees to 180 degrees and changes from 180 degrees to 270 degrees.

Consequently, in a depth pixel array having a 1-tap structure, a depth frame in the rolling shutter performed by the depth sensor 10 according to some embodiments described herein may be shorter than a depth frame in the conventional rolling shutter.

Accordingly, FIG. 3 illustrates other embodiments described herein, wherein at (b), charge is stored in a third pixel row, such as ROW_Y, in response to a gating signal, while simultaneously storing charge in a fourth pixel row, such as ROW_X, in response to a phase-changed version of the gating signal, shown in (b) of FIG. 3 as a 90 degree phase delayed version of the gating signal. These embodiments may be employed separately, as shown in (b) of FIG. 3, or may be employed with any combination or sub-combination of embodiments of (b) of FIG. 2 that were described above. Moreover, analogous depth sensors may be provided by (b) of FIG. 3 in combination with FIG. 1 and may also be provided in further combination with (b) of FIG. 2.

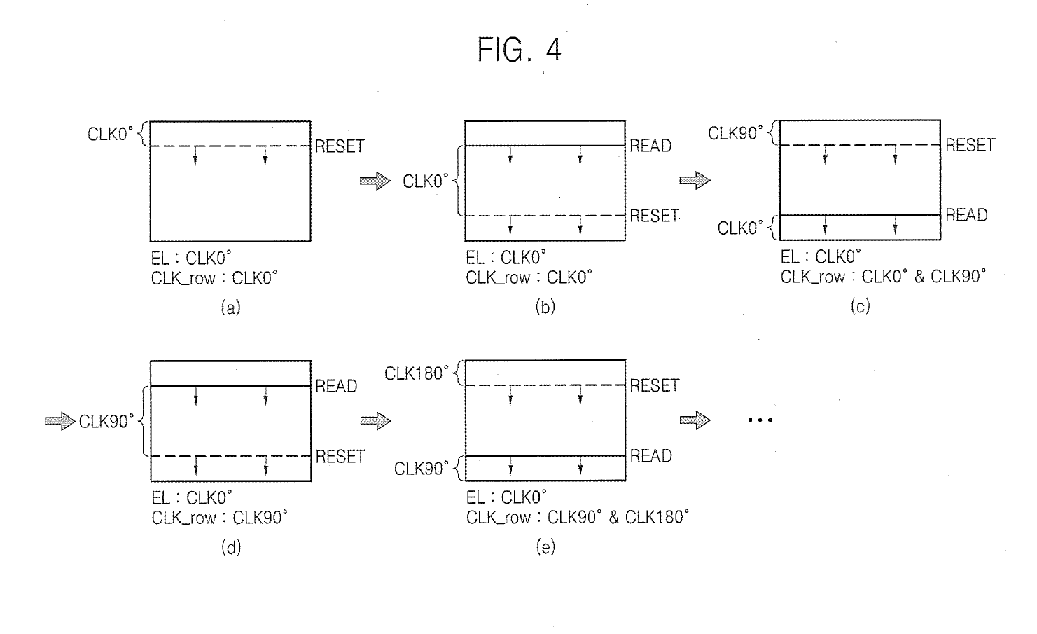

FIG. 4 is a diagram explaining the change in the gating signal applied to the plurality of rows in the depth sensor array 14 of the depth sensor 10 having a 1-tap structure according to various embodiments described herein. Referring to FIG. 4, the phase of the optical signal EL emitted to the object 11 is fixed to 0 degrees and the phase of the gating signal applied to the rows increases by 90 degrees.

The plurality of rows are sequentially reset and a gating signal CLK_row with a phase of 0 degrees starts to be applied to the rows sequentially in stage (a). Then, a photocharge accumulation result starts to be read from the rows to which the gating signal CLK_row with the phase of 0 degrees has been applied in stage (b). At this time, a clock signal with a phase of 0 degrees is only applied to a current frame.

While results of photocharge accumulation based on the gating signal CLK_row with the phase of 0 degrees are being read, rows with respect to which the reading has been completed are sequentially reset and the gating signal CLK_row with a phase of 90 degrees is applied to the reset rows sequentially in stage (c). At this time, the gating signal CLK_row with the phase of 0 degrees and the gating signal CLK_row with the phase of 90 degrees are simultaneously applied to the current frame.

Then, a photocharge accumulation result starts to be read from rows to which the gating signal CLK_row with the phase of 90 degrees has been applied in stage (d). At this time, the clock signal with a phase of 90 degrees is only applied to the current frame.

While results of photocharge accumulation based on the gating signal CLK_row with the phase of 90 degrees are being read, rows with respect to which the reading has been completed are sequentially reset and the gating signal CLK_row with a phase of 180 degrees is applied to the reset rows sequentially in stage (e). At this time, the gating signal CLK_row with the phase of 90 degrees and the gating signal CLK_row with the phase of 180 degrees are simultaneously applied to the current frame.

The above-described operation also applies when the phase of the gating signal CLK_row change from 180 to 270 degrees. This will be understood from the above description to those of ordinary skill in the art. Thus, detailed description thereof will be omitted.

As described above, the depth sensor 10 using a rolling shutter in the depth sensor array 14 having a 1-tap structure according to various embodiments described herein controls only the gating signal CLK_row applied to the rows in the depth sensor array 14 with the phase of the optical signal EL emitted to the object 11 fixed.

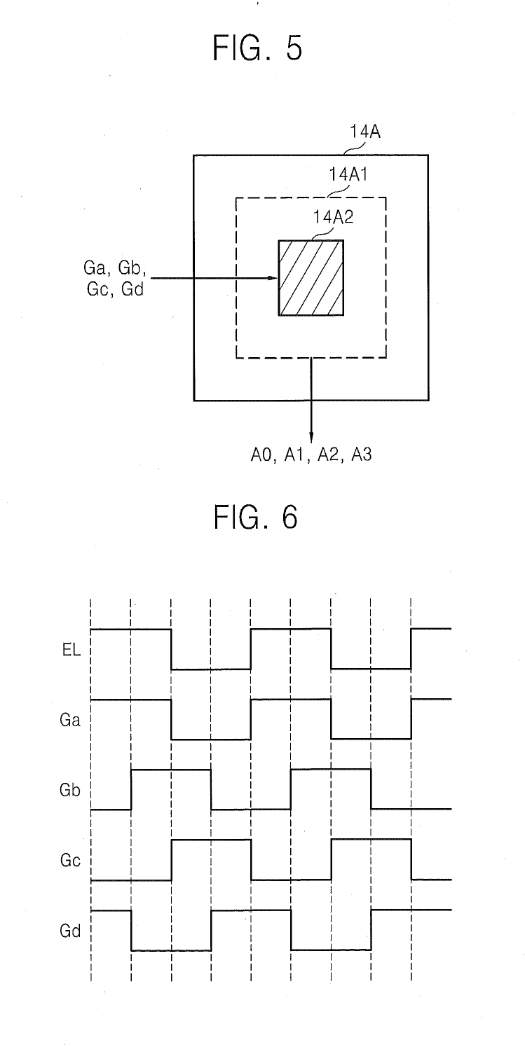

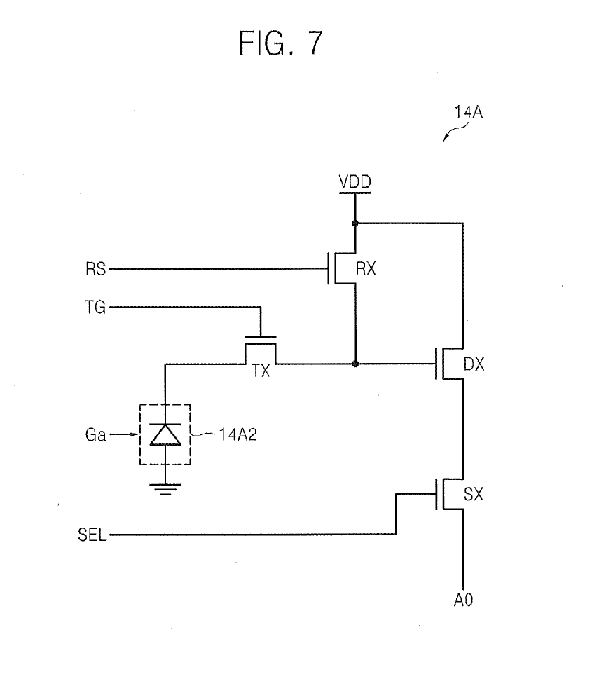

FIG. 5 is a layout of a depth pixel 14A included in the depth sensor array 14 of the depth sensor 10 having a 1-tap structure. FIG. 6 is a diagram showing gating signals Ga, Gb, Gc, and Gd applied to the depth pixel 14A in a 1-tap pixel structure illustrated in FIG. 5.

Each of the depth pixels included in the depth sensor array 14 may be implemented by the depth pixel 14A having the 1-tap pixel structure illustrated in FIG. 5. The depth pixel 14A having the 1-tap pixel structure may generate frame signals A0, A1, A2, and A3 in response to the four gating signals Ga, Gb, Gc, and Gd having a 90-degree phase difference. The frame signals A0, A1, A2, and A3 indicate results of reading photocharge accumulation results with respect to the gating signals with phases of 0, 90, 180, and 270 degrees, respectively, with respect to a single frame.

The frame signals A0, A1, A2, and A3 are converted into digital signals through CDS and ADC by the CDS/ADC circuit 18 and then stored in the memory 24. The depth estimator 26 estimates the distance to the object 11 based on the frame signals A0, A1, A2, and A3 output from the memory 24. The depth sensor 10 illustrated in FIG. 1 may also include active load circuits (not shown) transmitting frame signals output from the column lines of the depth sensor array 14 to the CDS/ADC circuit 18.

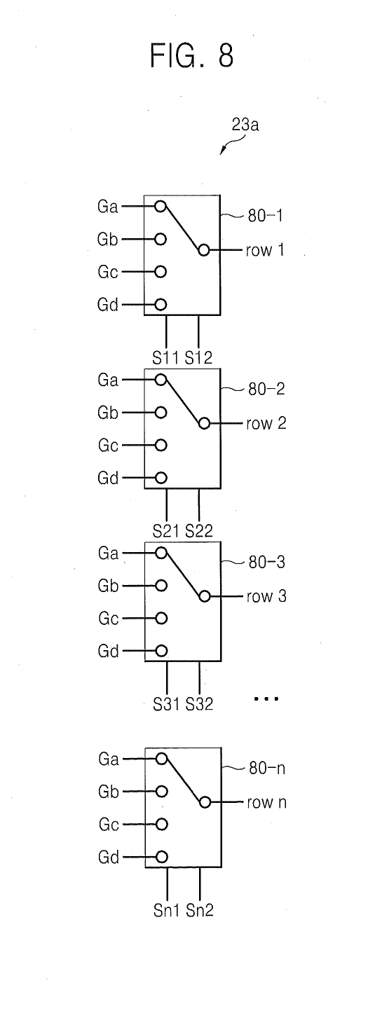

FIG. 7 is a circuit diagram of a photoelectric conversion element 14A2 and transistors in an active area 14A1 illustrated in FIG. 5. As illustrated in FIG. 5, the depth pixel 141A with the 1-tap pixel structure includes the photoelectric conversion element 14A2 implemented in the active area 14A1.

Referring to FIG. 7, the active area 14A1 includes the photoelectric conversion element 14A2 and four transistors RX, TX, DX, and SX. The photoelectric conversion element 14A2 may generate photocharge based on the each of the gating signals Ga, Gb, Gc, and Gd shown in FIG. 6 and the reflected optical signal RL. The photocharge generated in the photoelectric conversion element 14A2 may be output in response to a plurality of control signals RS, TG, and SEL output from the row control block 23.

The photoelectric conversion element 14A2 is a photo sensitive device and may be implemented by a photo diode, a photo transistor, a photo gate, a photo diode (PPD) and/or other photo sensitive device.

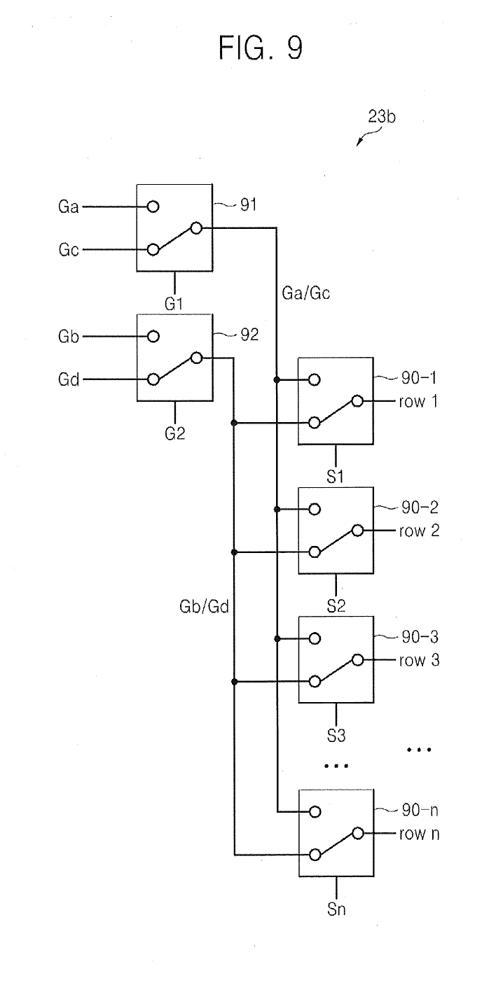

FIG. 8 is a schematic block diagram of an example 23a of the row control block 23 illustrated in FIG. 1. Referring to FIG. 8, the row control block 23a includes as many multiplexers 80-1 through 80-n as the number of rows. Each of the multiplexers 80-1 through 80-n is a 4×1 multiplexer and selects one from among the four gating signals Ga, Gb, Gc, and Gd in response to selection signals Si1 and Si2 (where “i” is an integer from 1 through “n”). For instance, the first multiplexer 80-1 selects one gating signal from among the 0-degree gating signal Ga, the 90-degree gating signal Gb, the 180-degree gating signal Gc, and the 270-degree gating signal Gd in response to the selection signals S11 and S12 and outputs the selected gating signal to the first row. Similarly, each of the other multiplexes 80-2 through 80-n also selects one gating signal from among the 0-, 90-, 180- and 270-degree gating signals Ga, Gb, Gc, and Gd in response to corresponding selection signals Si1 and Si2 and outputs the selected gating signal to a corresponding row among the second through n-th rows. Since the multiplexers 80-1 through 80-n are 4×1 multiplexers, the selection signals Si1 and Si2 may be implemented in a 2-bit digital signal.

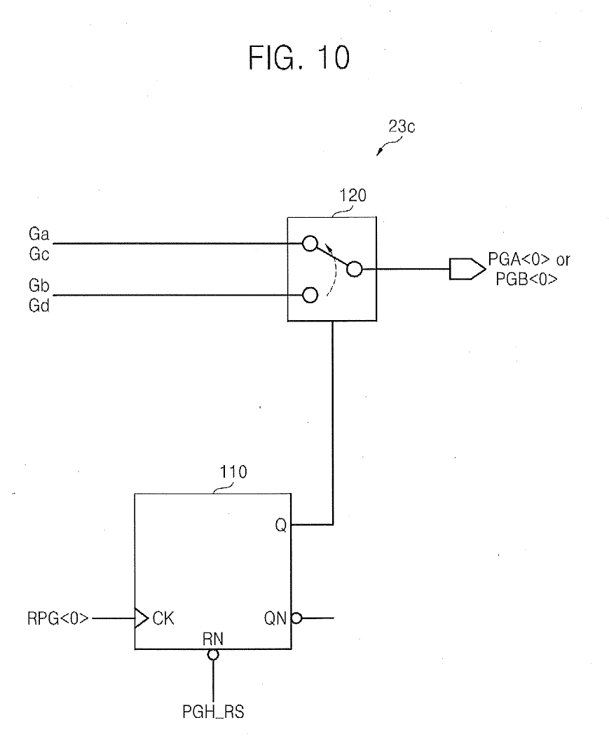

FIG. 9 is a schematic block diagram of another example 23b of the row control block 23 illustrated in FIG. 1. Referring to FIG. 9, the row control block 23b includes two global multiplexers 91 and 92 and local multiplexers 90-1 through 90-n as many as the number of row. Each of the multiplexers 91, 92, and 90-1 through 90-n are 2×1 multiplexers.

The first global multiplexer 91 selects and outputs either of the 0- and 180-degree gating signals Ga and Gc in response to a first global selection signal G1. The second global multiplexer 92 selects and outputs either of the 90- and 270-degree gating signals Gb and Gd in response to a second global selection signal G2. Each of the local multiplexers 90-1 through 90-n selects and outputs either of the output signals of the first and second global multiplexers 91 and 92 in response to a local selection signal Si (where “i” is an integer from 1 through “n”). The first and second global selection signals G1 and G2 may be 1-bit signals and may be at the same or different logic levels.

When the first and second global selection signals G1 and G2 are all “0”, the 0-degree gating signal Ga and the 90-degree gating signal Gb are selected and output. In this case, the first local multiplexer 90-1 selects and outputs either of the 0- and 90-degree gating signals Ga and Gb to the first row in response to the local selection signal S1. In the similar manner, each of the other local multiplexers 90-2 through 90-n selects and outputs either of the 0- and 90-degree gating signals Ga and Gb to a corresponding one of the second through n-th rows in response to a corresponding local selection signal Si.

When the first and second global selection signals G1 and G2 are all “1”, the 180-degree gating signal Gc and the 270-degree gating signal Gd are selected and output. In this case, the first local multiplexer 90-1 selects and outputs either of the 180- and 270-degree gating signals Gc and Gd to the first row in response to the local selection signal Si. In the similar manner, each of the other local multiplexers 90-2 through 90-n selects and outputs either of the 180- and 270-degree gating signals Gc and Gd to the corresponding one of the second through n-th rows in response to the corresponding local selection signal Si.

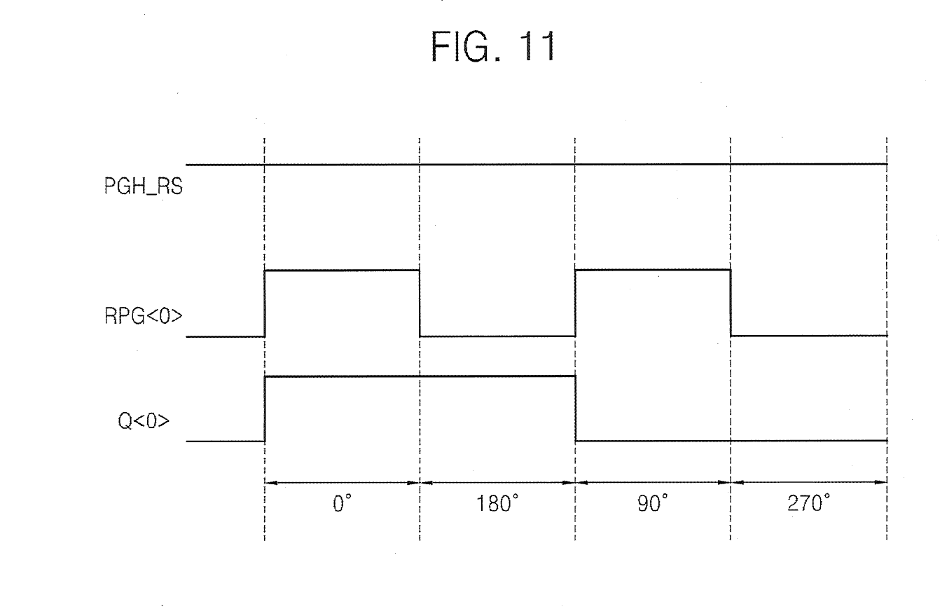

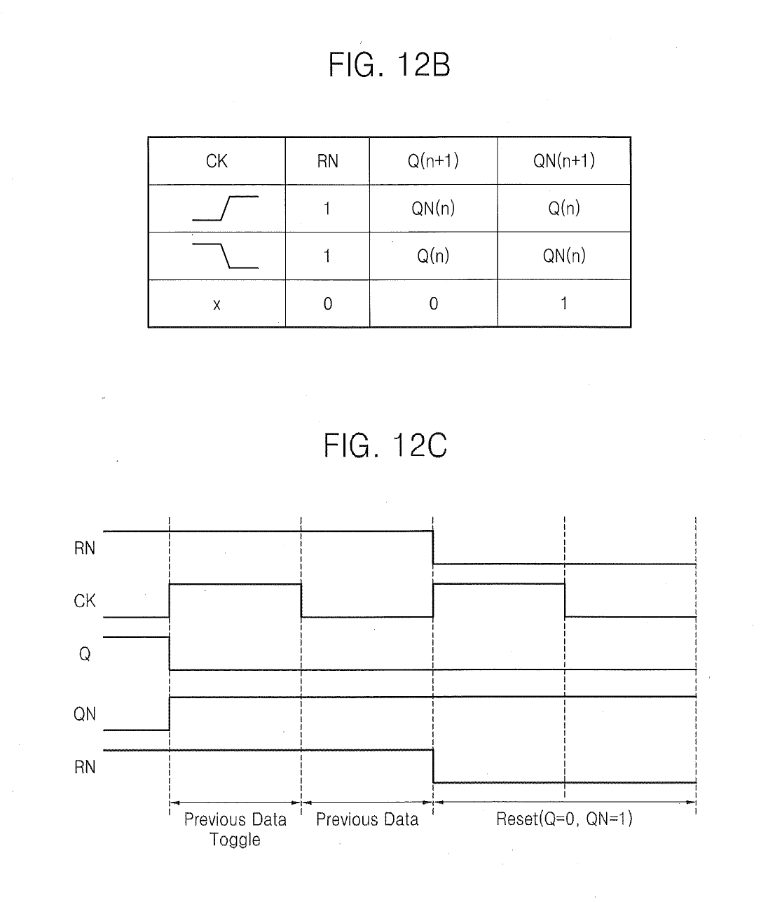

FIG. 10 is a block diagram of a part of a further example 23c of the row control block 23 illustrated in FIG. 1. Referring to FIG. 10, the row control block 23c includes a flip-flop 110 and a multiplexer 120. An example embodiment of the flip-flop 110, a truth table, and the operation of the flip-flop 110 are respectively illustrated in FIGS. 12A through 12C. Referring to FIGS. 12A through 12C, the flip-flop 110 includes a plurality of inverters IV1 through IV6 and a plurality of NOR gates NOR1 and NOR2.

The operation of the flip-flop 110 will be described below with reference to FIGS. 12B and 12C. When a clock signal CK transits from a first logic level (e.g., a low level) to a second logic level (e.g., a high level) while a node RN is 1, a QN value QN(n) before the transition is output as a Q output Q(n+1). In other words, Q(n+1) is an inverted value of QN(n). When the clock signal CK transits from the high level to the low level while the node RN is 1, a Q value Q(n) before the transition is output as the Q output Q(n+1). In other words, Q(n+1) is the same as QN(n). When the node RN is 0, Q(n+1) is 0 and QN(n+1) is 1, regardless of the clock signal CK.

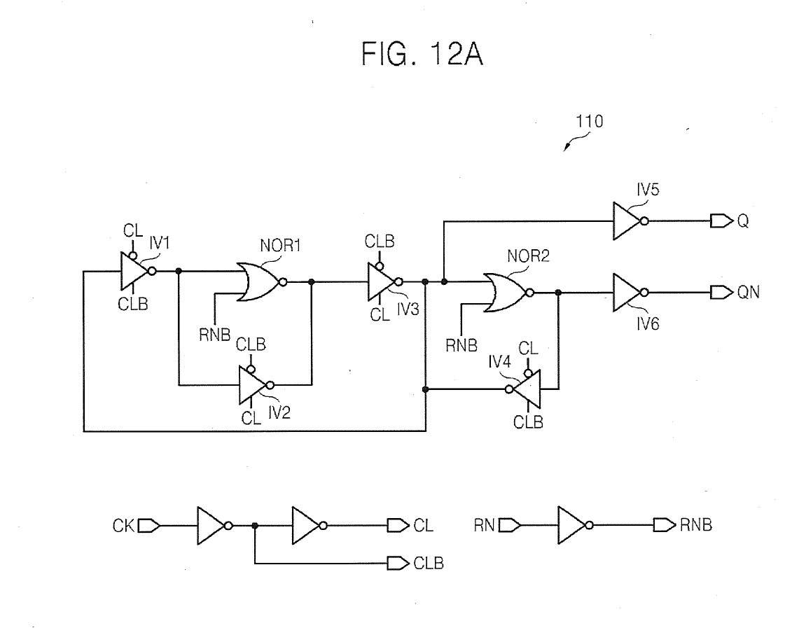

FIG. 11 is a schematic timing chart showing the operation of the row control block 23c illustrated in FIG. 10. The operation of the row control block 23c will be described with reference to FIGS. 10 and 11 below.

A decoded row address RPG<0> is input to a clock node CK of the flip-flop 110 and a gating reset signal PGH_RS is input to the node RN. The gating reset signal PGH_RS and the decoded row address RPG<0> may be as shown in FIG. 11.

When the decoded row address RPG<0> transits from “0” to “1”, Q<0> transits from “0” to “1”. When the decoded row address RPG<0> transits from “1” to “0”, Q<0> is maintained at “1”. When the decoded row address RPG<0> transits from “0” to “1” again, Q<0> is inverted from “1” to “0”. Thereafter, when the decoded row address RPG<0> transits from “1” to “0”, Q<0> is maintained at “0”. While Q<0> is “0”, the multiplexer 120 sequentially selects and outputs the 0-degree gating signal Ga and the 180-degree gating signal Gc. While Q<0> is “1”, the multiplexer 120 sequentially selects and outputs the 90-degree gating signal Gb and the 270-degree gating signal Gd.

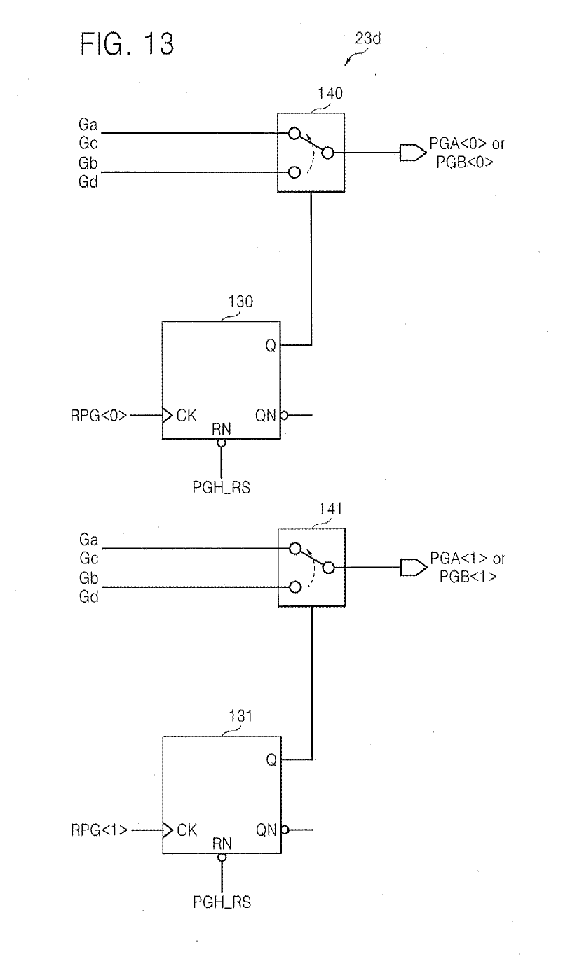

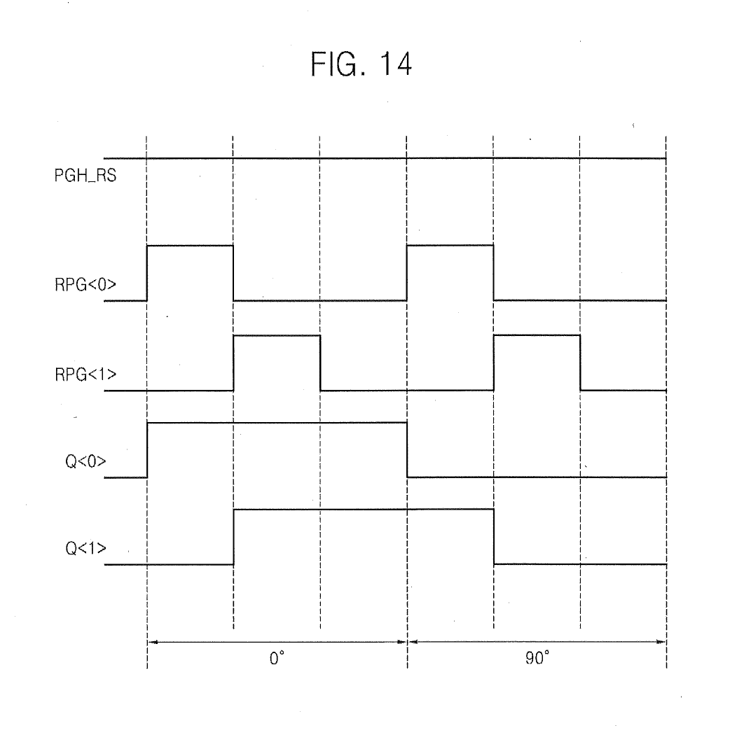

FIG. 13 is a block diagram of a part of another example 23d of the row control block 23 illustrated in FIG. 1. Referring to FIG. 13, the row control block 23d includes flip-flops 130 and 131 and multiplexers 140 and 141. FIG. 14 is a schematic timing chart showing the operation of the row control block 23d illustrated in FIG. 13. The operation of the row control block 23d will be described with reference to FIGS. 13 and 14 below.

An example embodiment of each of the flip-flops 130 and 131, a truth table, and the operation of each flip-flop 130 or 131 are the same as those illustrated in FIGS. 12A through 12C. Thus, detailed description thereof will be omitted.

A gating reset signal PGH_RS is input to a node RN of each of the first and second flip-flops 130 and 131 and a first decoded row address RPG<0> and a second decoded row address RPG<1> are respectively input to clock nodes CK of the respective first and second flip-flops 130 and 131. The gating reset signal PGH_RS and the first and second decoded row addresses RPG<0> and RPG<1> may be as shown in FIG. 14.

When the first decoded row address RPG<0> transits from “0” to “1” for the first time, Q<0> transits from “0” to “1”. When the decoded row address RPG<0> transits from “0” to “1” again after transiting from “1” to “0”, Q<0> is inverted from “1” to “0”. When the second decoded row address RPG<1> transits from “0” to “1” for the first time following the first decoded row address RPG<0>, Q<1> transits from “0” to “1”. When the second decoded row address RPG<1> transits from “0” to “1” again after transiting from “1” to “0”, Q<1> is inverted from “1” to “0”. The multiplexer 140 selects and outputs the 0-degree gating signal Ga While Q<0> is “0” and selects and outputs the 90-degree gating signal Gb while Q<0> is “1”. The operation of the second multiplexer 141 is similar to that of the first multiplexer 140.

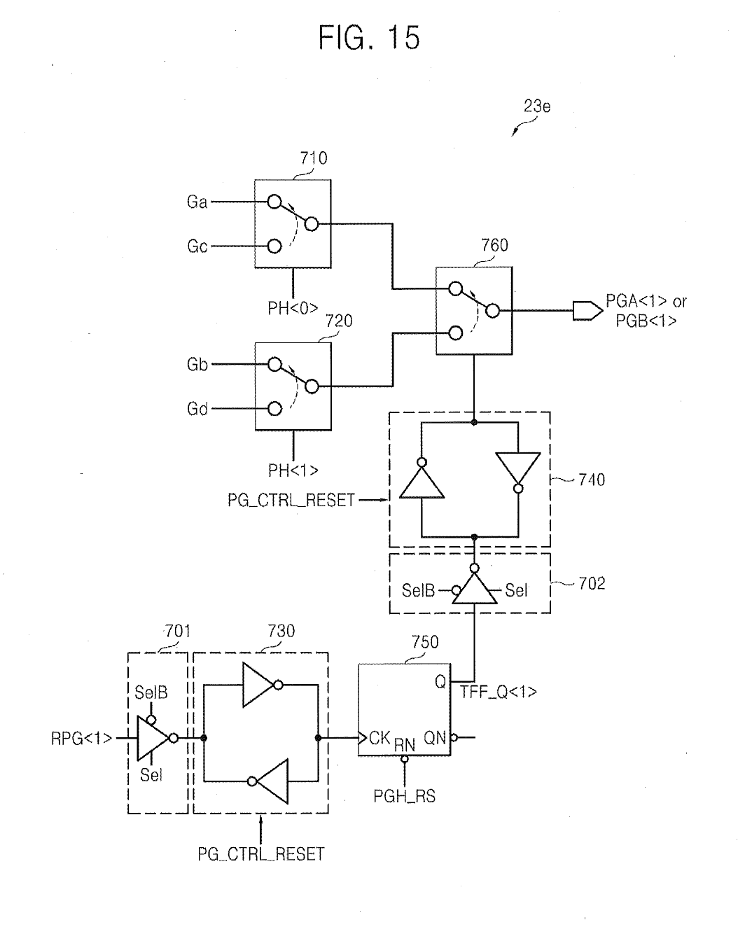

FIG. 15 is a block diagram of a part of a yet another example 23e of the row control block 23 illustrated in FIG. 1. Referring to FIG. 15, the row control block 23e includes first and second inverters 701 and 702, first and second latches 730 and 740, a flip-flop 750, and first through third multiplexers 710, 720, and 760. As compared to the row control block 23d illustrated in FIG. 13, the row control block 23e illustrated in FIG. 15 further includes the first and second latches 730 and 740 and the first and second inverters 701 and 702. The first inverter 701 transmits a decoded row address RPG<1> to the first latch 730 only when a selection signal SEL is high, The second inverter 702 transmits a Q output TFF_Q<1> of the flip-flop 750 to the second latch 740 only when the selection signal SEL is high.

Accordingly, when the selection signal SEL is high, the decoded row address RPG<1> is input to the row control block 23e, latched by the first latch 730, and input to a clock node CK of the flip-flop 750. At this time, as has been described with reference to FIGS. 13 and 14, when the decoded row address RPG<1> transits from “0” to “1” for the first time, the Q output TFF_Q<1> transits from “0” to “1”. When the decoded row address RPG<1> transits from “0” to “1” again after transiting from “1” to “0”, the Q output TFF_Q<1> is inverted from “1” to “0”. When the selection signal SEL is low, the decoded row address RPG<1> is not input to the row control block 23e.

The part of the row control block 23e illustrated in FIG. 15 is a structure provided just for a first row. The structure illustrated in FIG. 5 may be provided for other rows.

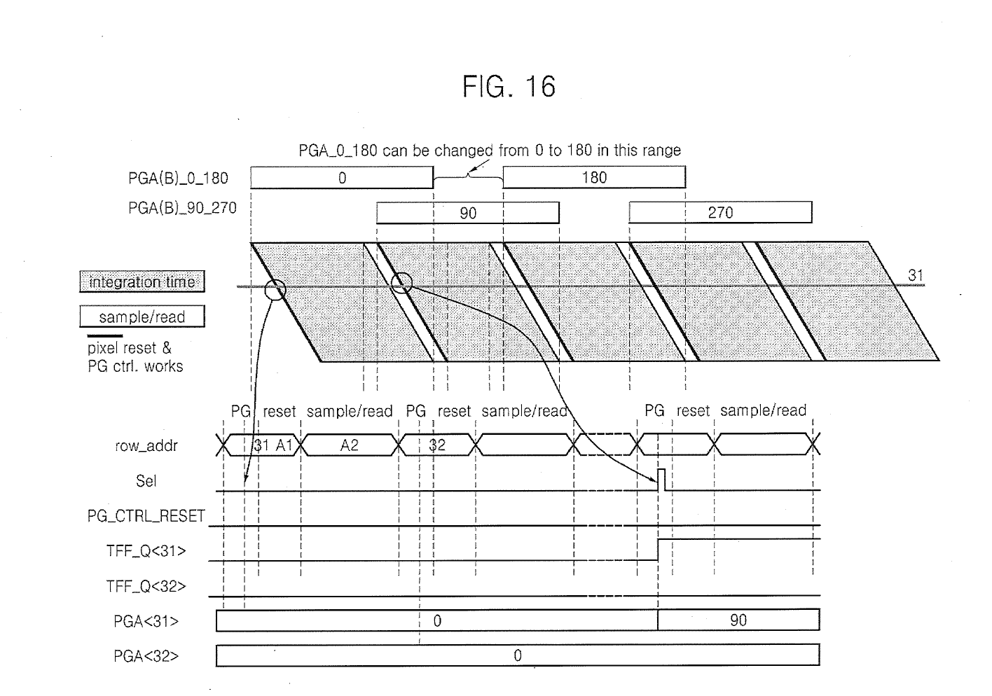

FIGS. 16 and 17 are timing charts showing the operation of the depth sensor 10 including the row control block 23e illustrated in FIG. 15.

Referring to FIG. 16, a row address row_addr is input to the depth sensor 10 to select a row to which a gating signal PGA or PGB and a reset signal are applied or a row to be sampled or read. Here, it is assumed that a 31st row address and a 32nd row address are input. Even when the row address row_addr is input to the depth sensor 10, it is not input to the row control block 23e when a selection signal Sel is low. Accordingly, a Q output TFF_Q<31> of a flip-flop for the 31st row and a Q output TFF_Q<32> of a flip-flop for the 32nd row are also maintained low. When the Q outputs TFF_Q<31> and TFF_Q<32> of the flip-flops are low, gating signals PGA<31> and PGA<32> respectively applied to the 31st and 32nd rows are 0-degree gating signals.

When the selection signal Sel transits to high, a current row address, i.e., the 31st row address is input to the row control block 23e. Then, the Q output TFF_Q<31> of the flip-flop for the 31st row transits from low to high. As a result, the gating signal PGA<31> applied to the 31st row is changed into a 90-degree gating signal.

Referring to FIG. 17, a row address row_addr is input to the depth sensor 10 to select a row to which a gating signal PGA or PGB and a reset signal are applied or a row to be sampled or read. Here, it is assumed that a 31st row address and a 32nd row address are input.

When a selection signal Sel transits to high for the first time, a current row address, i.e., the 31st row address is input to the row control block 23e. Then, a Q output TFF_Q<31> of a flip-flop for the 31st row transits from low to high. As a result, a gating signal PGA<31> applied to the 31st row is changed from a 0-degree gating signal to a 90-degree gating signal.

When the selection signal Sel transits to high for the second time, a current row address, i.e., the 32nd row address is input to the row control block 23e. Then, a Q output TFF_Q<32> of a flip-flop for the 32nd row transits from low to high. As a result, a gating signal PGA<32> applied to the 32nd row is changed from the 0-degree gating signal to the 90-degree gating signal.

When the selection signal Sel transits to high for the third time, a current row address, i.e., the 31st row address is input to the row control block 23e. Then, the Q output TFF_Q<31> of the flip-flop for the 31st row transits from high to low. As a result, the gating signal PGA<31> applied to the 31st row is changed from the 90-degree gating signal to a 180-degree gating signal.

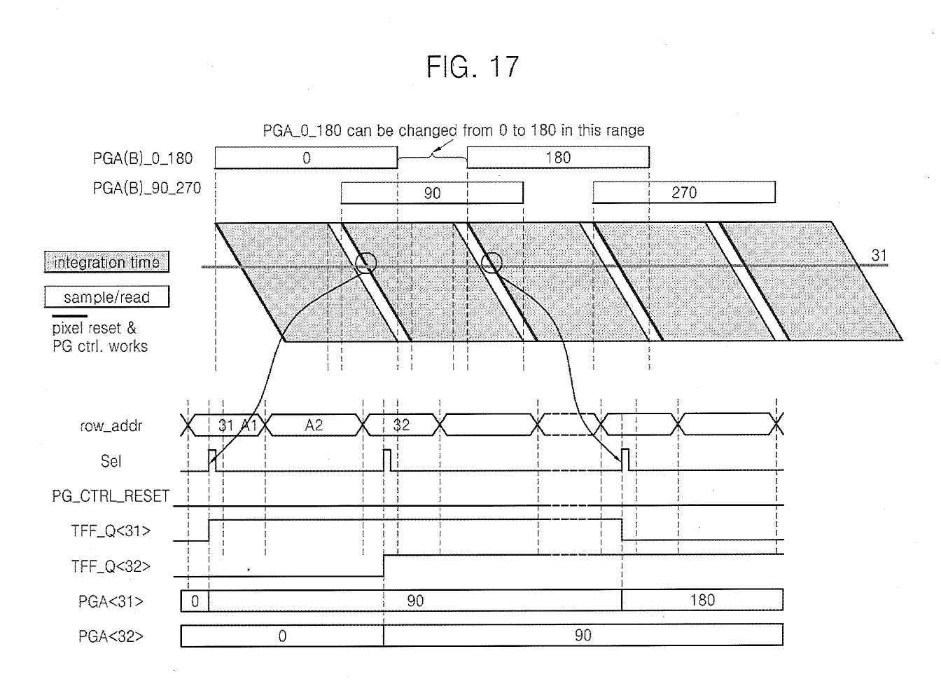

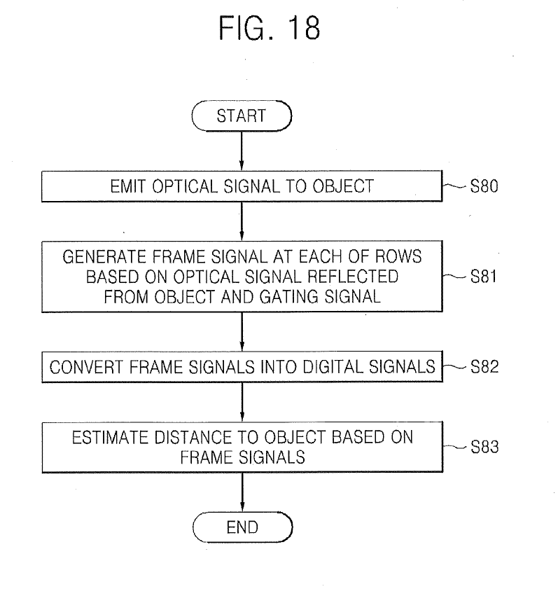

FIG. 18 is a flowchart of operations that may be performed to estimate a distance using the depth sensor 10 according to various embodiments described herein. Referring to FIGS. 1 and 18, the optical signal EL is emitted by the IR emitter 12 to the object 11 in block S80. The row control block 23 sequentially applies a gating signal to the plurality of rows in the depth sensor array 14. Then, the depth sensor array 14 generates photocharge (i.e., a frame signal) accumulated at each of the rows in response to the optical signal RL reflected from the object 11 and the gating signal in block S81. Block S81 will be described in detail with reference to FIG. 19 later.

Thereafter, the CDS/ADC circuit 18 converts a plurality of frame signals output from the depth sensor array 14 into digital signals in block S82. The depth estimator 26 estimates the distance to the object 11 based on the frame signals in block S83.

FIG. 19 is a flowchart of operations that may be performed for block S81 of generating the frame signals in the flowchart illustrated in FIG. 18 using the depth sensor 10 including a depth pixel array having a 1-tap structure. The plurality of rows are sequentially reset for a single frame and a gating signal with a phase of 0 degrees is sequentially applied to the reset rows in block S81A. Then, photocharge is accumulated at each of the rows, to which the gating signal with the phase of 0 degrees has been applied, in block S81B. Thereafter, a photocharge accumulation result is read from each of the rows sequentially in order of elapse of an integration time in block S81C. The phase of the gating signal applied to the rows sequentially in order of completion of the reading is increased by 90 degrees in block S81D.

Thereafter, the depth sensor 10 determines whether an increment in the phase of the gating signal applied to each of the rows is greater than 270 degrees in block S81E. When the increment in the phase of the gating signal applied to a current row is 360 degrees, block S81 ends. When the increment in the phase of the gating signal is not greater than 270 degrees, the gating signal having the increased phase angle is sequentially applied to the rows that have been reset in block S81A and blocks S81B through S81E are repeated.

A technique for estimating a depth using a rolling shutter in the depth sensor 10 including the depth sensor array 14 having a 1-tap structure has been described above. The technique using the rolling shutter in which the phase of an optical signal is fixed and the phase of a gating signal is only controlled to increase a frame rate may also be applied to a depth sensor including a depth sensor array having a 2-tap structure.

The structure and the operations of a depth sensor having the 2-tap structure are similar to those of a depth sensor having the 1-tap structure, but the depth sensor having the 2-tap structure is different from the depth sensor having the 1-tap structure in the structure of, for example, a depth pixel, a gating signal applied to the depth pixel, and a signal output from the depth pixel. These differences will be described in a rolling shutter used in a depth sensor array having the 2-tap structure.

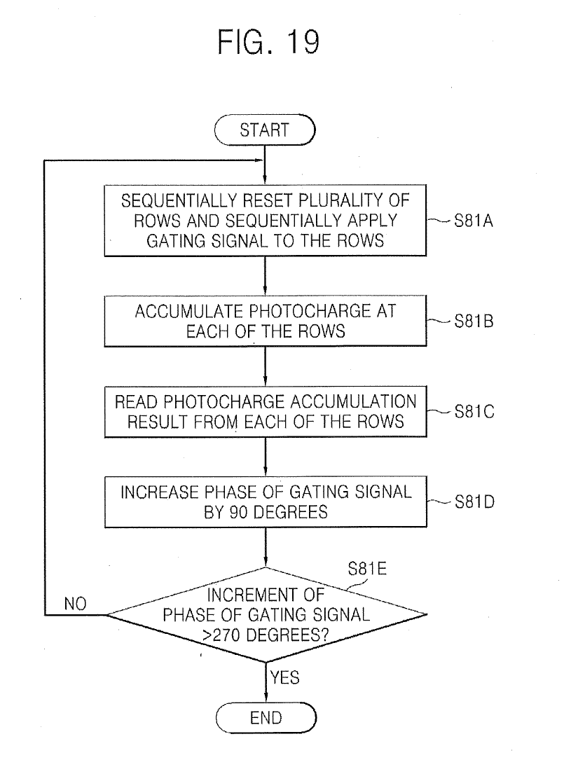

FIG. 20 is a layout of a depth pixel 14B included in a depth sensor array of a depth sensor having the 2-tap structure. Unlike the depth pixel 14A illustrated in FIG. 5, the depth pixel 14B in the 2-tap structure includes two active areas 14B1 and 14B3 and two photoelectric conversion elements 14B2 and 14B4.

The depth pixel 14A illustrated in FIG. 5 sequentially generates the frame signals A0 through A3 in response to the gating signals Ga through Gd having phases sequentially increasing. However, the depth pixel 14B illustrated in FIG. 20 simultaneously generates a pair of frame signals A0 and A2 in response to a gating signal Ga with the same phase as an optical signal and a gating signal Gc with an opposite phase to the optical signal and then simultaneously generates a pair of frame signals A1 and A4 in response to a gating signal Gb having a 90-degree phase difference from an optical signal and a gating signal Gd with an opposite phase to the optical signal.

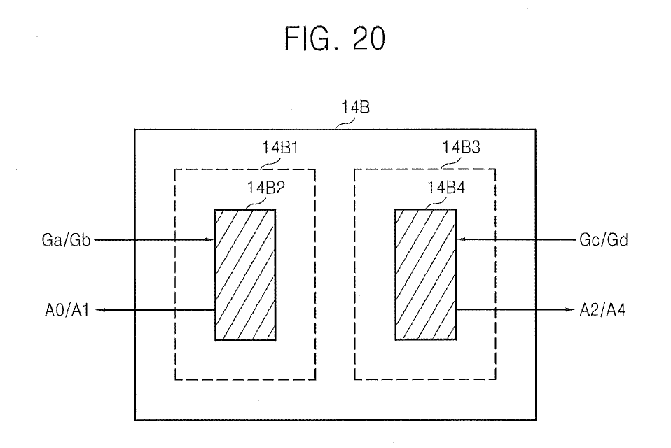

FIG. 21 is a diagram comparing a conventional rolling shutter (a) for a single frame with a rolling shutter (b) performed in a depth sensor having a 2-tap structure according to various embodiments described herein. Here, it is assumed that the optical signal EL emitted by the IR emitter 12 has a phase of 0 degrees.

When the conventional rolling shutter (a) is used, with respect to the single frame, only after the read operation of a result of photocharge accumulation based on each of the gating signals respectively having 0 and 180 degrees is completed, the read operation of a result of photocharge accumulation based on each of the gating signals respectively having 90 and 270 degrees is performed.

However, in the rolling shutter (b) performed in the depth sensor according to the current embodiments described herein, with respect to the single frame, even while the read operation of a result of photocharge accumulation based on each of gating signals respectively having phases of 0 and 180 degrees is being performed, photocharge accumulation based on each of gating signal respectively having phases of 90 and 270 degrees starts at a row at which the read operation of a photocharge accumulation result has been completed.

In other words, in the rolling shutter (b) performed in the depth sensor according to the current embodiments, a period of photocharge accumulation in at least one pair of reset rows ROW_X1 and ROW_X2 respectively based on the gating signals having changed phases overlaps a period of photocharge accumulation in at least one pair of rows ROW_Y1 and ROW_Y2 in which photocharge accumulation based on the gating signals having phases before being changed is being carried out.

Accordingly, FIG. 21 illustrates methods of operating a depth sensor, wherein charge is stored in a first pixel row in response to a gating signal while simultaneously storing charge in a second pixel row in response to a phase-changed version of the gating signal, while simultaneously storing charge in a third pixel row in response to a further phase-changed version of the gating signal. These embodiments may be provided independently or may be combined with embodiments that were described in connection with (b) of FIG. 2. Related depth sensors may also be provided.

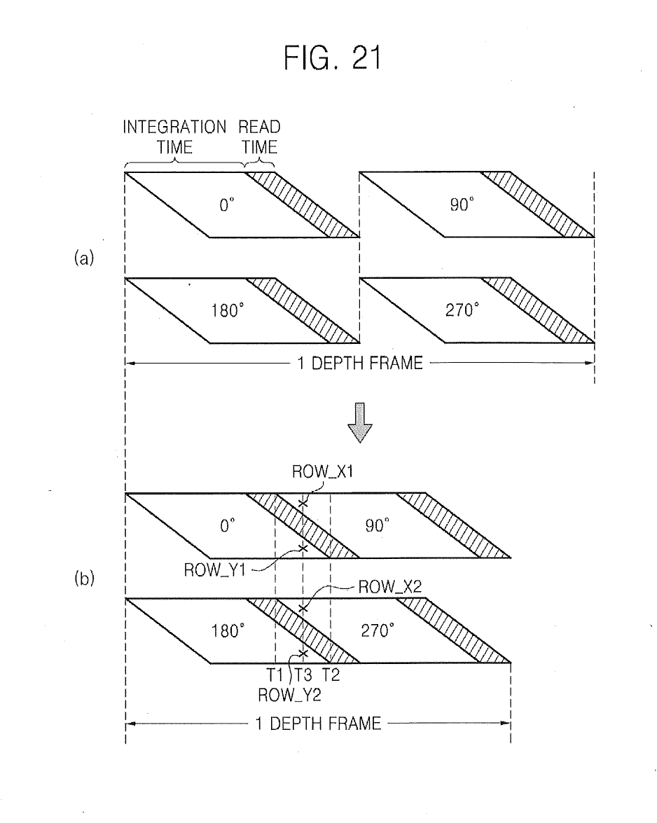

FIG. 22 is a diagram explaining the change in a gating signal applied to a plurality of rows in a depth sensor array of a depth sensor having a 2-tap structure according to various embodiments described herein. Referring to FIG. 22, the phase of the optical signal EL emitted to the object 11 is fixed to 0 degrees and the phases of a pair of gating signals applied to the rows increase by 90 degrees.

The plurality of rows are sequentially reset and a pair of gating signals CLK_row respectively having phases of 0 and 180 degrees start to be applied to the rows sequentially in stage (a). Then, a photocharge accumulation result starts to be read from the rows to which the gating signals CLK_row respectively having the phases of 0 and 180 degrees have been applied. At this time, only the pair of the gating signals CLK_row with the phases of 0 and 180 degrees are applied to a current frame.

While results of photocharge accumulation based on the pair of the gating signals CLK_row with the phases of 0 and 180 degrees are being read, rows with respect to which the reading has been completed are sequentially reset and a pair of the gating signals CLK_row respectively having phases of 90 and 270 degrees are applied to the reset rows sequentially in stage (b). At this time, the gating signals CLK_row with the phases of 0, 90, 180 and 270 degrees are simultaneously applied to the current frame.

Then, a photocharge accumulation result starts to be read from rows to which the pair of the gating signals CLK_row with the phases of, 90 and 270 degrees have been applied in stage (c). At this time, the gating signals CLK_row with the phases of 90 and 270 degrees are applied to the current frame.

While results of photocharge accumulation based on the pair of the gating signals CLK_row with the phases of 90 and 270 degrees are being read, rows with respect to which the reading has been completed are sequentially reset and the pair of the gating signals CLK_row with the phases of 0 and 180 degrees are applied to the reset rows sequentially in stage (d). At this time, the gating signals CLK_row with the phases of 0, 90, 180 and 270 degrees are simultaneously applied to the current frame. The above-described operation including stage (e) is also applied to a subsequent frame.

As described above, a depth sensor using a rolling shutter in a depth sensor array having a 2-tap structure according to various embodiments described herein also controls only a pair of the gating signals CLK_row applied to the rows in the depth sensor array while the phase of the optical signal EL emitted to the object 11 fixed, thereby increasing a frame rate.

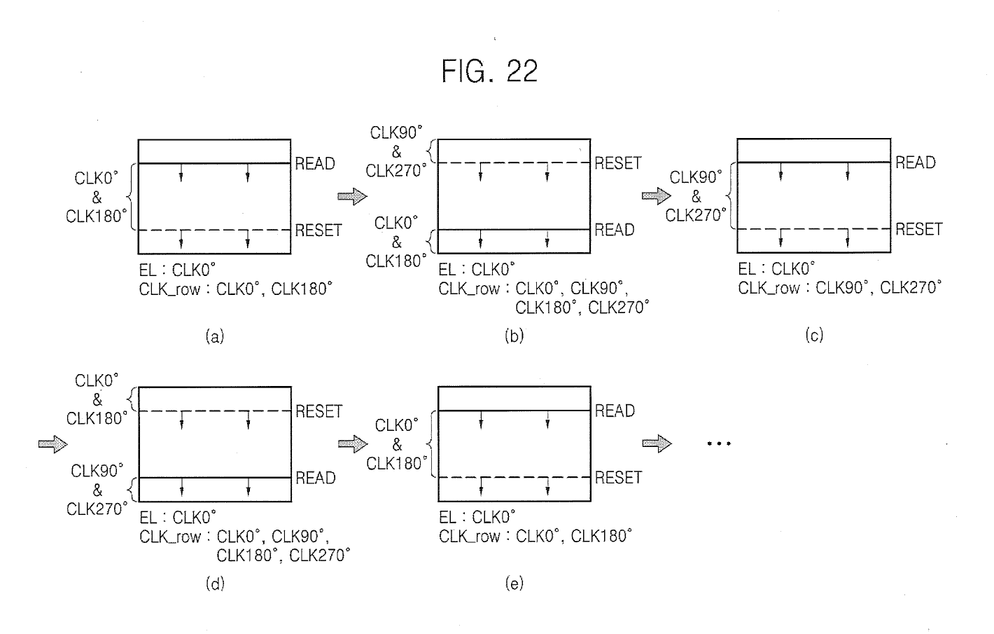

FIG. 23 is a flowchart of operations that may be performed corresponding to block S81 of generating the frame signals in the flowchart illustrated in FIG. 18 in a depth sensor including a depth pixel array having a 2-tap structure. The plurality of rows are sequentially reset for a single frame and a pair of gating signals respectively having phases of 0 and 180 degrees are applied to the reset rows sequentially in block S81A′. Then, photocharge is accumulated at each of the rows, to which the pair of gating signals with the phases of 0 and 180 degrees have been applied, in block S81B′. Thereafter, a photocharge accumulation result is read from each of the rows sequentially in order of elapse of an integration time in block S81C′. The phases of the pair of gating signals applied to the rows sequentially in order of completion of the reading are increased by 90 degrees in block S81D′.

Thereafter, the depth sensor determines whether an increment in the phase of the gating signal applied to each of the rows is greater than 180 degrees in block S81E′. When the increment in the phase of the gating signal applied to a current row is 180 degrees, operations end. When the increment in the phase of the gating signal is not greater than 180 degrees, the pair of gating signals having the increased phase angles are applied to the rows sequentially that have been reset in block S81A′ and blocks S81B′ through S81E′ are repeated.

Each of the elements in the depth sensor 10 or a combination thereof may be mounted using various types of packages such as a Package on Package (PoP), a Ball Grid Array (BGA), a Chip Scale Package (CSP), a Plastic Leaded Chip Carrier (PLCC), a Plastic Dual In-line Package (PDIP), a die in waffle pack, a die in wafer form, a Chip On Board (COB), a CERamic Dual In-line Package (CERDIP), a plastic Metric Quad Flat Pack (MQFP), a Thin Quad Flat Pack (TQFP), a Small Outline Integrated Circuit (SOIC), a Shrink Small Outline Package (SSOP), a Thins Small Outline Package (TSOP), a System In Package (SIP), a Multi Chip Package (MCP), a Wafer-level Fabricated Package (WFP), and/or a Wafer-level processed Stack Package (WSP).

Methods of estimating a distance using the depth sensor 10 according to various embodiments described herein can be embodied as computer readable code in a computer readable recording medium. The methods can be realized by executing a computer program stored in the computer readable recording medium to perform the method

The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

The computer readable recording medium can also be distributed over network coupled computer systems so that the computer readable code is stored and executed in a distributed fashion. Also, functional programs, codes, and code segments for accomplishing the methods can be easily construed by programmers skilled in the art to which the present invention pertains.

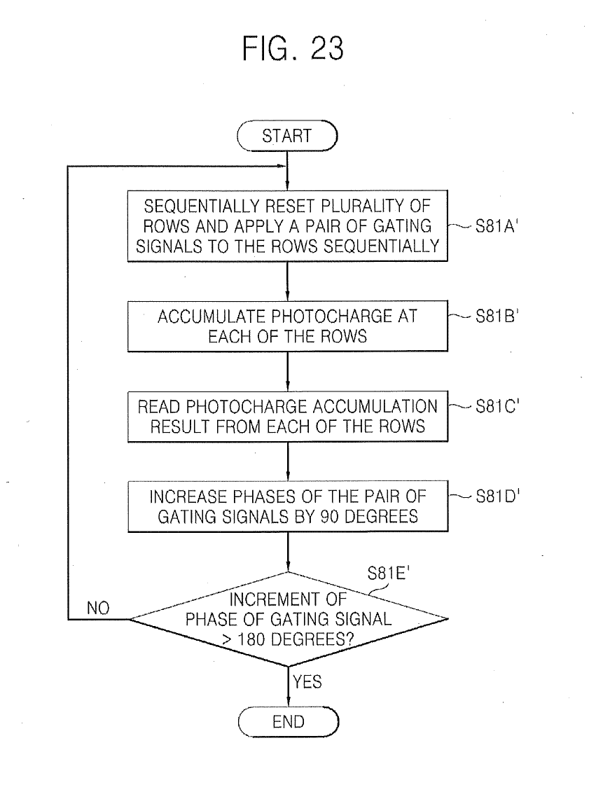

FIG. 24 is a block diagram of a 3D image sensor 100 according to various embodiments described herein. The 3D image sensor 100 is a device that can acquire 3D image information by combining a function of measuring depth information using a depth pixel and a function of measuring color information (e.g., red (R) color information, green (G) color information, or blue (B) color information) using an R, G, or B color pixels.

Referring to FIG. 24, the 3D image sensor 100 includes a decoder 22′, a row control block 23′, a PG driver 25′, the depth sensor array 14, an image sensor array 110, the CDS/ADC circuit 18′, and an image signal processor (ISP) 120. The 3D image sensor 100 may also include a column decoder (not shown). The column decoder may decode column addresses output from a timing controller (not shown) and output column selection signals. For clarity of the description, many other elements that may be included in the 3D image sensor 100 are not illustrated in FIG. 24.

The row control block 23′ may generate control signals for controlling the operation of each of pixels included in the depth sensor array 14 and pixels included in the image sensor array 110. As has been described with reference to FIGS. 1 through 23 above, the depth sensor array 14 may generate and output depth information for estimation of the distance to the object 11. The image sensor array 110 may generate and output image information.

The CDS/ADC circuit 18′ may convert signals output from the depth sensor array 14 and the image sensor array 110 into digital signals. The ISP 120 may generate a 3D image signal based on the digital signals output from the CDS/ADC circuit 18′.

The ISP 120 may include the memory 24 and/or the depth estimator 26 illustrated in FIG. 1. Accordingly, the ISP 120 may estimate depth information using a depth sensor and a method of estimating a depth using the same according to some embodiments described herein and combine the estimated depth information with color information to generate a 3D image signal.

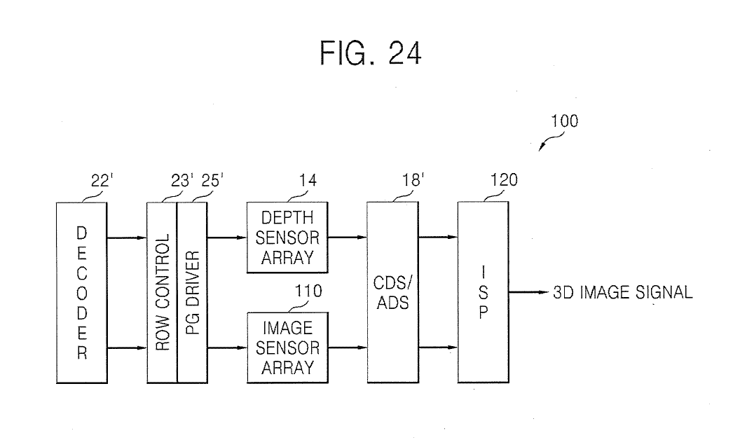

FIG. 25 is a block diagram of a signal processing system 200 including the depth sensor 10 illustrated in FIG. 1. Referring to FIG. 25, the signal processing system 200 functions as only a distance measuring sensor and includes the depth sensor 10, a processor 210, a memory 220, and an interface 230 which are connected to one another through a system bus 201.

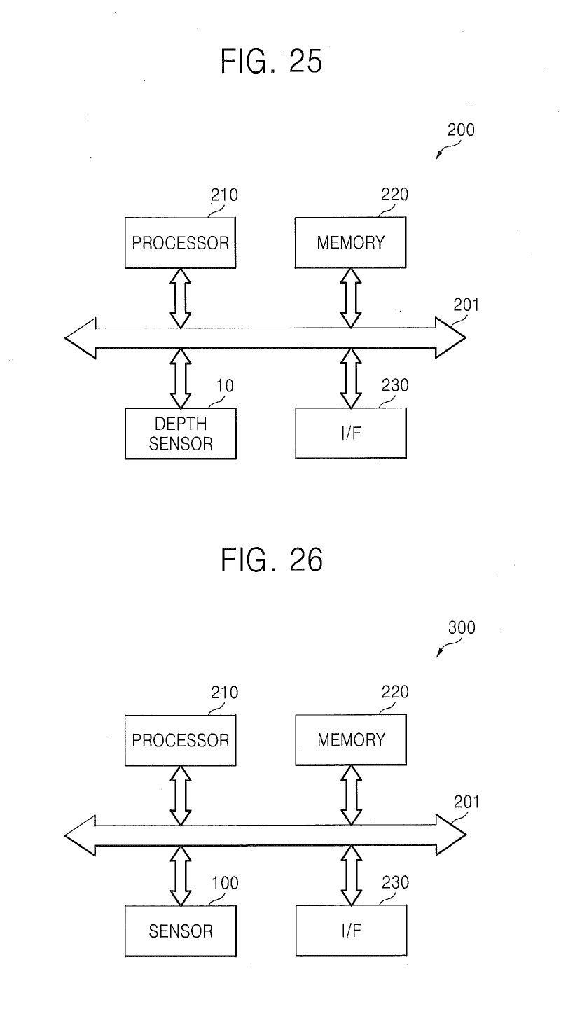

FIG. 26 is a block diagram of an image processing system 300 including the 3D image sensor 100 illustrated in FIG. 24. The image processing system 300 may generate 3D image information and display the 3D image information through a display device. Referring to FIG. 26, the image processing system 300 includes the 3D image sensor 100, the processor 210, the memory 220, and the interface 230 which are connected to one another through the system bus 201.

As described above, according to various embodiments described herein, the phase of a gating signal applied to rows in a pixel depth array of a depth sensor is controlled while the phase of an optical signal emitted to an object is fixed, so that a frame rate is increased.

Various embodiments are described in part herein with reference to block diagrams and flowcharts of methods, systems and computer program products according to various embodiments described herein. It will be understood that a block of the block diagrams or flowcharts, and combinations of blocks in the block diagrams or flowcharts, may be implemented at least in part by computer program instructions. These computer program instructions may be provided to one or more computer systems, such that the instructions, which execute via the computer system(s) create means, modules, devices or methods for implementing the functions/acts specified in the block diagram block or blocks. Combinations of general purpose computer systems and/or special purpose hardware also may be used in other embodiments.

These computer program instructions may also be stored in memory of the computer system(s) that can direct the computer system(s) to function in a particular manner, such that the instructions stored in the memory produce an article of manufacture including computer-readable program code which implements the functions/acts specified in block or blocks. The computer program instructions may also be loaded into the computer system(s) to cause a series of operational steps to be performed by the computer system(s) to produce a computer implemented process such that the instructions which execute on the processor provide steps for implementing the functions/acts specified in the block or blocks. Accordingly, a given block or blocks of the block diagrams and/or flowcharts provides support for methods, computer program products and/or systems (structural and/or means-plus-function).

It should also be noted that in some alternate implementations, the functions/acts noted in the flowcharts may occur out of the order noted in the flowcharts. For example, two blocks shown in succession may in fact be executed substantially concurrently or the blocks may sometimes be executed in the reverse order, depending upon the functionality/acts involved. Finally, the functionality of one or more blocks may be separated and/or combined with that of other blocks.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or sub combination.

While the present invention has been particularly shown and described with reference to various embodiments thereof, it will be understood by those of ordinary skill in the art that various changes in forms and details may be made therein without departing from the spirit and scope of the present invention as defined by the following claims.

1. A depth sensor comprising:
a depth sensor array comprising a plurality of rows each of which comprises a plurality of depth pixels, accumulates photocharge generated in response to an optical signal reflected from an object and a gating signal for an integration time, and outputs a result of photocharge accumulation in response to completion of the photocharge accumulation; and
a row control block configured to sequentially reset the plurality of rows and apply the gating signal to the plurality of rows sequentially,
wherein the row control block is further configured to change a phase of the gating signal applied to a row, with respect to which the outputting of the result of photocharge accumulation has been completed, by a predetermined angle, and to perform a plurality of cycles of application of the reset signal and the gating signal with respect to an entire single frame; and
wherein a period of photocharge accumulation in at least one reset row in response to the gating signal having a changed phase overlaps a period of photocharge accumulation in at least one row in which photocharge accumulation based on the gating signal having a phase before being changed is being carried out.

2. The depth sensor of claim 1, wherein a phase of an optical signal emitted to the object is fixed to generate the optical signal reflected from the object.

3. The depth sensor of claim 2, wherein the row control block sequentially applies to the plurality of rows the gating signal having the same phase as the optical signal emitted to the object at a first cycle among the plurality of cycles.

4. The depth sensor of claim 3, wherein the predetermined angle is 90 degrees.

5. The depth sensor of claim 3, wherein the row control block comprises a plurality of selectors each of which selects at least two gating signals having different phases from one another and applies the at least two gating signals to one of the plurality of rows.

6. The depth sensor of claim 1:
wherein the gating signal comprises a pair of gating signals;
wherein the row control block is configured to sequentially reset the plurality of rows and apply the pair of gating signals to the plurality of rows sequentially;
wherein the row control block is further configured to change a phase of each of the pair of gating signals applied to a row, with respect to which the outputting of the result of photocharge accumulation has been completed, by a predetermined angle, and to perform a plurality of cycles of application of the reset signal and the pair of gating signals with respect to an entire single frame; and
wherein a period of photocharge accumulation in at least one pair of reset rows in response to the pair of gating signals each having a changed phase overlaps a period of photocharge accumulation in at least one row in which photocharge accumulation based on the pair of gating signals each having a phase before being changed is being carried out.

7. The depth sensor of claim 6, wherein the pair of gating signals applied by the row control block to the plurality of rows sequentially at a first cycle among the plurality of cycles comprises a signal having a same phase as the optical signal emitted to the object and a signal having an opposite phase to the optical signal emitted to the object.

8. The depth sensor of claim 7, wherein row control block comprises:
a first global multiplexer configured to select and output either of a first gating signal or a second gating signal in response to a first global control signal;
a second global multiplexer configured to select and output either of a third gating signal or a fourth gating signal in response to a first global control signal; and
a plurality of multiplexers which correspond to the plurality of rows, respectively, and each of which selects and outputs either of outputs of the first or second global multiplexers to a corresponding one of the rows in response to a local selection signal.

9. The depth sensor of claim 8, wherein the row control block further comprises a flip-flop, a clock node of which receives a row address and a logic level of an output of which transits when the row address transits from a first logic level to a second logic level and remains when the row address transits from the second logic level to the first logic level; and
wherein the local selection signal is the output of the flip-flop.

10. A method of estimating a distance using a depth sensor, the method comprising:
(a) sequentially resetting a plurality of rows and applying a gating signal to the plurality of rows sequentially;
(b) accumulating at each of the rows photocharge generated in response to an optical signal reflected from an object and the gating signal for an integration time; and
(c) reading a result of photocharge accumulation from each of the rows sequentially in order of completion of the photocharge accumulation,
wherein (a) through (c) are sequentially repeated in a plurality of cycles;
wherein a phase of the gating signal applied to a row with respect to which the reading of the result of photocharge accumulation has been completed, is changed by a predetermined angle; and
wherein a period of photocharge accumulation based on the gating signal having a changed phase in at least one row, which has been subjected to the reading and then reset, overlaps a period of photocharge accumulation in at least one row in which photocharge accumulation based on the gating signal having a phase before being changed is being carried out.

11. The method of claim 10, wherein a phase of an optical signal emitted to the object is fixed to generate the optical signal reflected from the object; and
wherein a phase of the gating signal sequentially applies to the plurality of rows in (a) in a first cycle among the plurality of cycles is the same as a phase of the optical signal emitted to the object.

12. The method of claim 11, wherein the phase of the gating signal applied to the row, with respect to which the reading has been completed, is changed by the predetermined angle from the phase of the optical signal emitted to the object.

13. The method of claim 12, wherein (a) through (c) are repeated 4 cycles with respect to an entire single frame by changing the phase of the gating signal by an angle of 90 degrees at each cycle.

14. A method of operating a depth sensor that includes a plurality of pixel rows that sequentially store charge generated in response to an optical signal that is reflected from an object, the method comprising:
resetting a second pixel row that stores charge subsequent to a first pixel row stores charge, before the first pixel row has completed a reading operation of the charge that was stored therein.

15. The method of claim 14 wherein the resetting comprises resetting the second pixel row before the first pixel row has begun a reading operation of the charge that was stored therein.

16. The method of claim 14 wherein the resetting comprises resetting the second pixel row and beginning to store charge in the second pixel row, while the first pixel row is storing charge therein.

17. The method of claim 14 wherein the resetting comprises resetting the second pixel row and beginning to store charge in the second pixel row, immediately after a sufficient time has elapsed that provides non-overlapping reading operations of the first and second pixel rows.

18. The method of claim 14 further comprising:
storing charge in a third pixel row in response to a gating signal while simultaneously storing charge in a fourth pixel row in response to a phase-changed version of the gating signal.

19. The method of claim 14 further comprising storing charge in the first pixel row in response to a gating signal while simultaneously storing charge in the second pixel row in response to the phase-changed version of the gating signal, and while simultaneously storing charge in a third pixel row in response to a further phase-changed version of the gating signal.

20. A method of operating a depth sensor that includes a plurality of pixel rows that sequentially store charge generated in response to an optical signal that is reflected from an object, the method comprising:
storing charge in a first pixel row in response to a gating signal while simultaneously storing charge in a second pixel row in response to a phase-changed version of the gating signal.
